(19) United States
(12) Patent Application Publication
(10) Pub. No.: US 2004/0119880 A1
(43) Pub. Date: Jun. 24, 2004

(54) Extendable lens camera having mechanical shutter blocking in intermediate lens position

(75) Inventor: Anthony Dirisio, Rochester, NY (US)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 10/327,503

(22) Filed: Dec. 20, 2002

(51) Int. Cl. H04N 5/225

(52) U.S. Cl. 348/374

(57) ABSTRACT

A camera frame assembly has a frame and a shutter release mounted to the frame. The shutter release is selectively releaseable from a ready state to a released state. A lens base, which is joined to the frame, defines an optical axis. A lens barrel is movable along the optical axis between first and second positions relative to the lens base. A twist ring is reversibly rotatable relative to the lens base, from a rightward configuration, through intermediate configurations, to a leftward configuration. The twist ring is mechanically coupled to the lens barrel and rotation of the twist ring from rightward to leftward configuration moves the lens barrel from first to second position. A blocker has a first end joined to the frame, a second end connected to the twist ring, and an engagement portion between the ends. The engagement portion locks the shutter release in the intermediate configurations and unlocks the shutter release in either of the rightward and leftward configurations.

### CROSS REFERENCE TO RELATED APPLICATIONS

Reference is made to commonly assigned, co-pending U.S. patent application Ser. No. ______, [Attorney Docket No. 85329RLW], entitled: MULTIPLE POSITION LENS BARREL HAVING CAM CYLINDER WITH COMMONLY BIASED FIRST AND SECOND LENS CARRIERS, filed Oct. 4, 2002, in the name of Anthony Dirisio; Ser. No. ______, [Attorney Docket No. 85533RLW], entitled: CAMERA FRAME ASSEMBLY HAVING FOUR-BAR LINKAGE SHUTTER ACTUATOR, filed ______, in the name of Anthony Dirisio; Ser. No. ______, [Attorney Docket No. 85549RLW], entitled CAMERA LENS MODULE HAVING RECYCLABLE LENS BARREL CAP, filed ______, in the name of Anthony Dirisio; Ser. No. ______, [Attorney Docket No. 85553RLW], entitled: CAMERA FRAME ASSEMBLY HAVING SHUTTER THAT SLIDES FORWARD AND BACK WITH ZOOM LENS, filed ______, in the name of Anthony Dirisio, David J. Cornell; Ser. No. ______, [Attorney Docket No. 85554RLW], entitled: CAMERA FRAME ASSEMBLY HAVING SHUTTER ACTUATOR WITH TELESCOPING STRIKER AND METHOD, filed ______, in the name of David J. Cornell; Ser. No. ______, [Attorney Docket No. 85691RLW], entitled: CAMERA FRAME ASSEMBLY HAVING INDEPENDENTLY BACK-PIVOTING DRIVE HUB FOR IMPACT SHUTTER, filed ______, in the name of Anthony Dirisio.

### FIELD OF THE INVENTION

The invention relates to photography and cameras and more particularly relates to an extendable lens camera having mechanical shutter release blocking in intermediate lens positions.

### BACKGROUND OF THE INVENTION

A variety of different cameras are known that use an auxiliary lens to selectively provide a change in focal length. In these cameras, the auxiliary lens is moved in and out of the optical path, as desired, to change between telephoto and wide angle settings. Many cameras of this type used a rotatable turret to move the lens in and out of position. These cameras have a shortcoming that, during lens movement, propagation of light through the optical path is interfered with and pictures should not be taken.

A response to this problem has been the provision of an interlock in the camera that prevents picture taking when the cover lens is between its two alternative positions. U.S. Pat. No. 4,544,249 discloses an electrical control system that provides this function. This is an effective approach, but tends to be expensive for a simple camera.

A number of different mechanical blockers that inhibit shutter release during movement of an auxiliary lens have been described. The blockers are limited in their applicability to particular camera mechanisms and in their particular spatial requirements within a camera body.

U.S. Pat. No. 4,961,084 discloses a camera having a mechanism that uses a combination of levers to provide a shutter release, a telephoto-wide angle switch, and a blocker that inhibits shutter actuation during movement of an auxiliary lens. This mechanism is relatively complex, does not allow for mechanical actuation of an impact shutter, and requires a large amount of space in a plane aligned with a planar front surface of the camera.

U.S. Pat. No. 4,529,283 discloses a camera having a lens turret, an impact shutter, and a blocker mechanism that blocks shutter release during movement of the turret between positions. The blocker mechanism requires a large amount of space in a plane parallel to a planar front of the camera.

U.S. Pat. No. 4,536,068 discloses a camera having a pivotable auxiliary lens. The camera includes a blocker mechanism that prevents shutter release during movement of the auxiliary lens. Locking and unlocking of the shutter release, by the blocker mechanism, is directly controlled by movement of a lens-holding cover unit, back and forth in an axial direction.

U.S. Pat. No. 3,903,537 discloses a camera in which lenses are used alternately. The lenses are slid linearly back and forth between active and inactive positions. The shutter release is locked when the lenses are between those positions. The blocker mechanism is part of a piece that moves back and forth with the lenses.

It would thus be desirable to provide a camera frame assembly having a mechanical shutter blocker that only requires a small amount of space and is movable by a rotating part of a lens assembly.

### SUMMARY OF THE INVENTION

The invention is defined by the claims. The invention, in broader aspects, provides a camera frame assembly has a frame and a shutter release mounted to the frame. The shutter release is selectively releaseable from a ready state to a released state. A lens base, which is joined to the frame, defines an optical axis. A lens barrel is movable along the optical axis between first and second positions relative to the lens base. A twist ring is held in unchanging axial relation to the lens base. The twist ring is reversibly rotatable relative to the lens base, from a rightward configuration, through intermediate configurations, to a leftward configuration. The twist ring is mechanically coupled to the lens barrel and rotation of the twist ring from rightward to leftward configuration moves the lens barrel from first to second position. A blocker has a first end joined to the frame, a second end connected to the twist ring, and an engagement portion between the ends. The engagement portion locks the shutter release in the intermediate configurations and unlocks the shutter release in either of the rightward and leftward configurations.

It is an advantageous effect of the invention that an improved camera frame assembly is provided that has a mechanical shutter blocker, which only requires a small amount of space and is movable by a rotating part of a lens assembly.

### BRIEF DESCRIPTION OF THE DRAWINGS

The above-mentioned and other features and objects of this invention and the manner of attaining them will become more apparent and the invention itself will be better understood by reference to the following description of an embodiment of the invention taken in conjunction with the accompanying figures wherein:

FIG. 1 is a top view of an embodiment of the camera frame assembly. The traveler is in an intermediate position.

FIG. 2 is the same view as FIG. 1, but the traveler is in the wide-angle position.

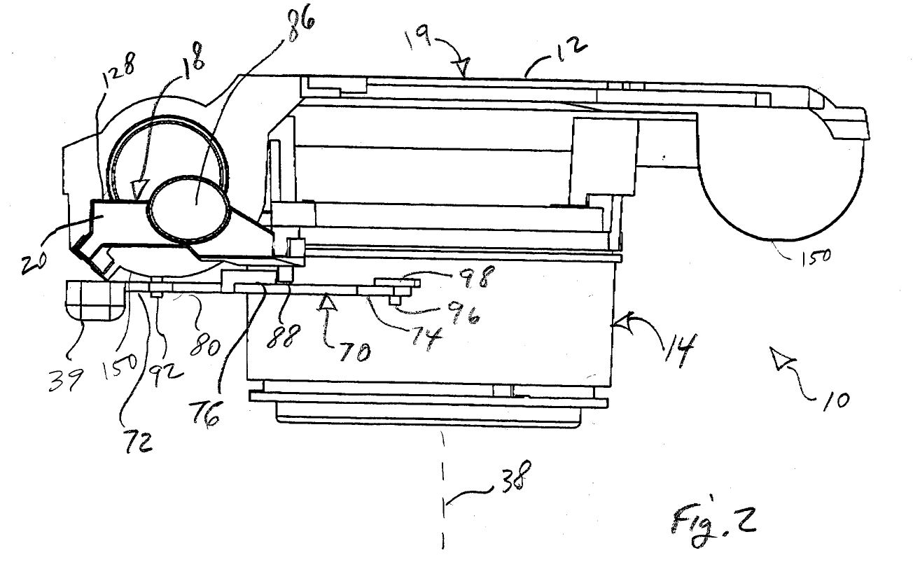

FIG. 3 is the same view as FIG. 1, but the traveler is in the telephoto position.

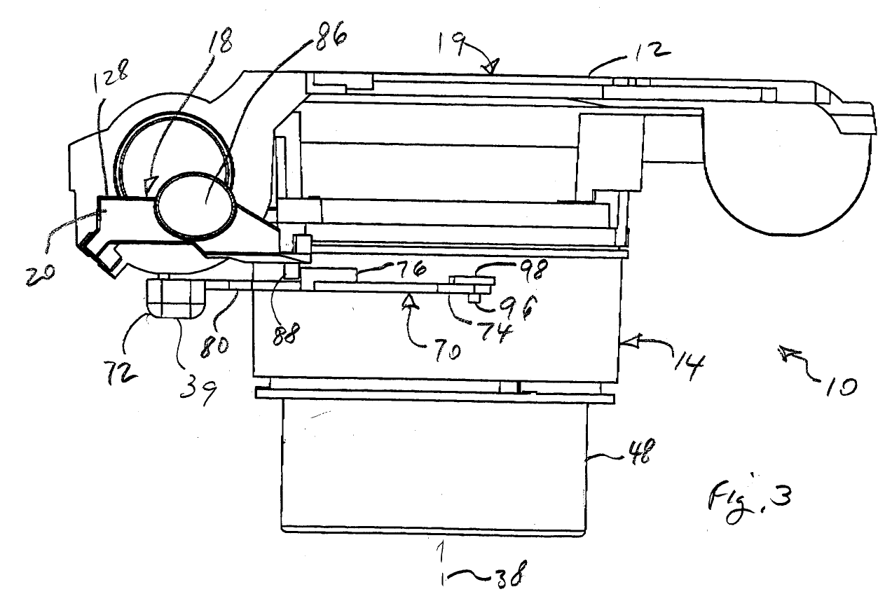

FIG. 4 is a front perspective view of a camera incorporating the camera frame assembly of FIG. 1.

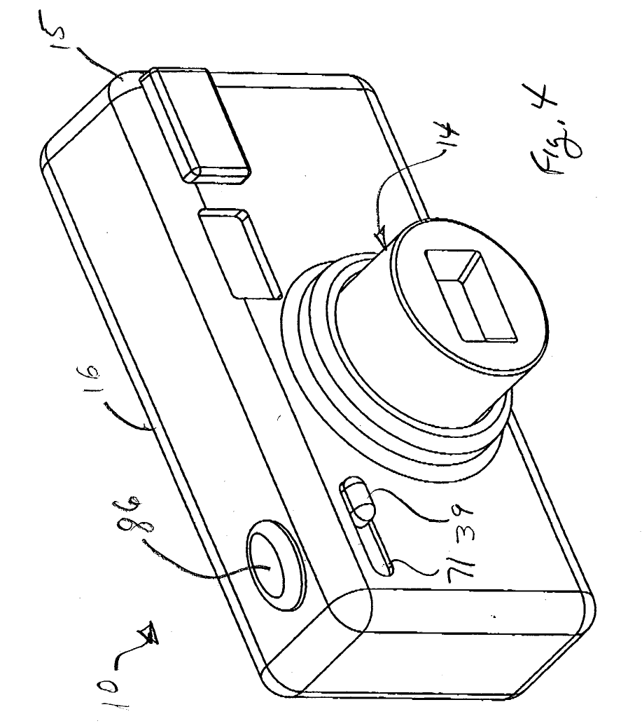

FIG. 5 is an exploded, front perspective view of the camera of FIG. 4.

FIG. 6 is a front perspective view of the camera frame assembly of FIG. 1. The traveler is in the wide-angle position.

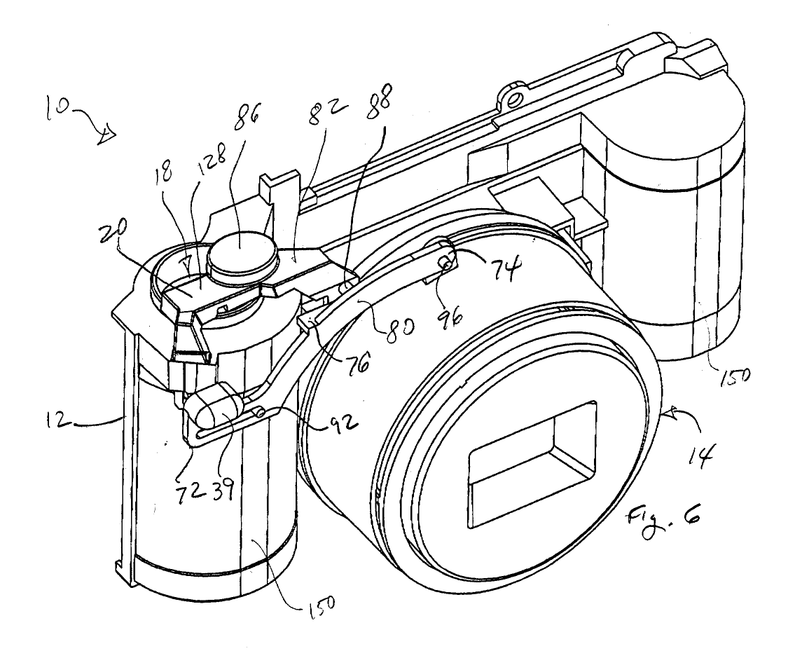

FIG. 7 is the same view as FIG. 6, but the traveler is in the telephoto position.

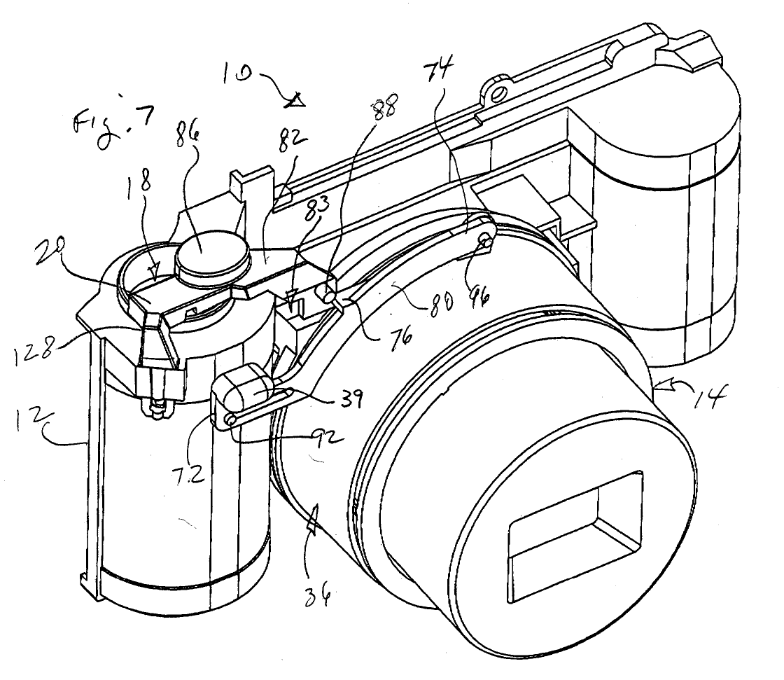

FIG. 8 is a diagrammatical front view of the shutter mechanism of the camera of FIG. 4. The blocker is in a locking position and the shutter driver is charged.

FIG. 9 is the same view as FIG. 8, but the blocker is shown in a first unlocking position (solid line) and a second unlocking position (dashed line). The shutter driver is shown in a charged state.

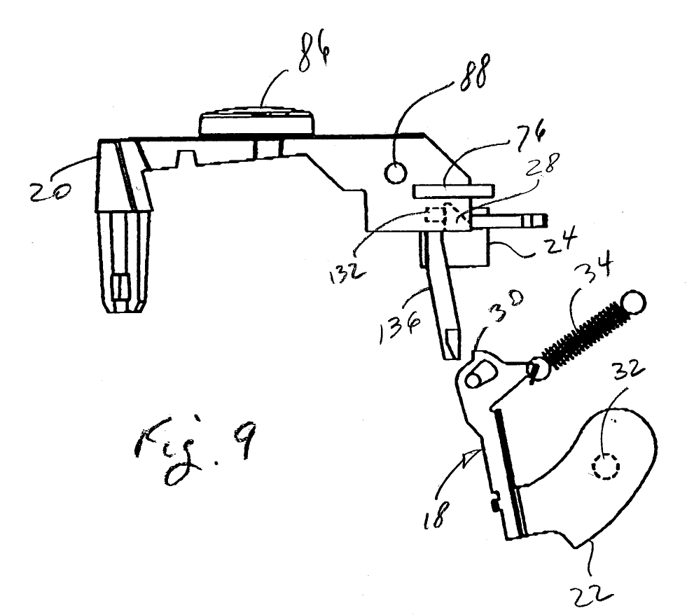

FIG. 10 is the same view as FIG. 8, but the shutter driver is in a discharged state.

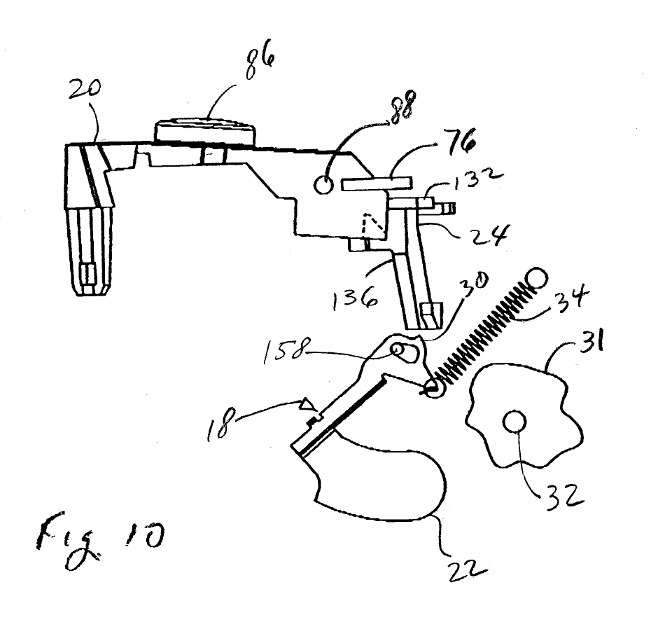

FIG. 11 is a top view of the shutter mechanism of FIG. 8. The blocker is in a locking position and the shutter driver is charged. Also shown are parts of the winding mechanism and a film cartridge.

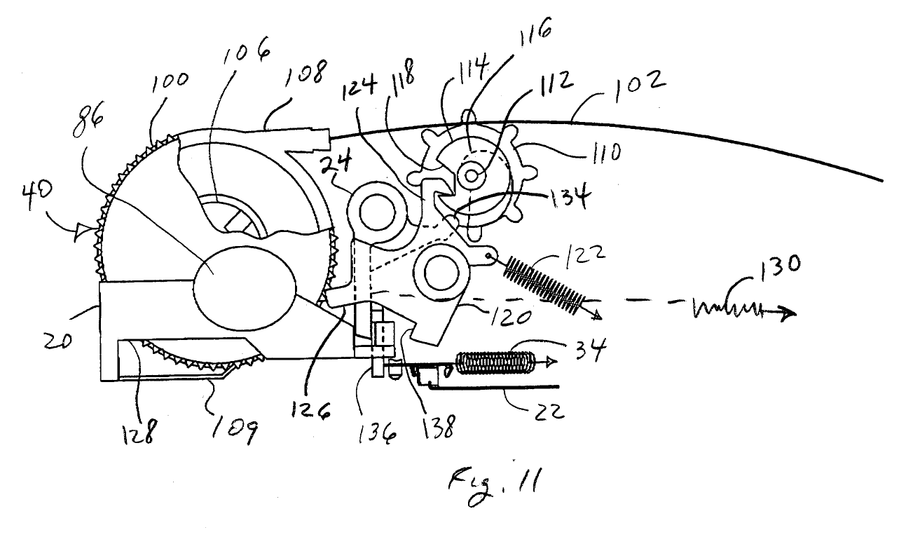

FIG. 12 is a partially exploded perspective view of the lens module of FIG. 1.

FIG. 13 is a front perspective view of another embodiment of the camera frame assembly.

FIG. 14 is a partially exploded, front perspective view of the camera of FIG. 13.

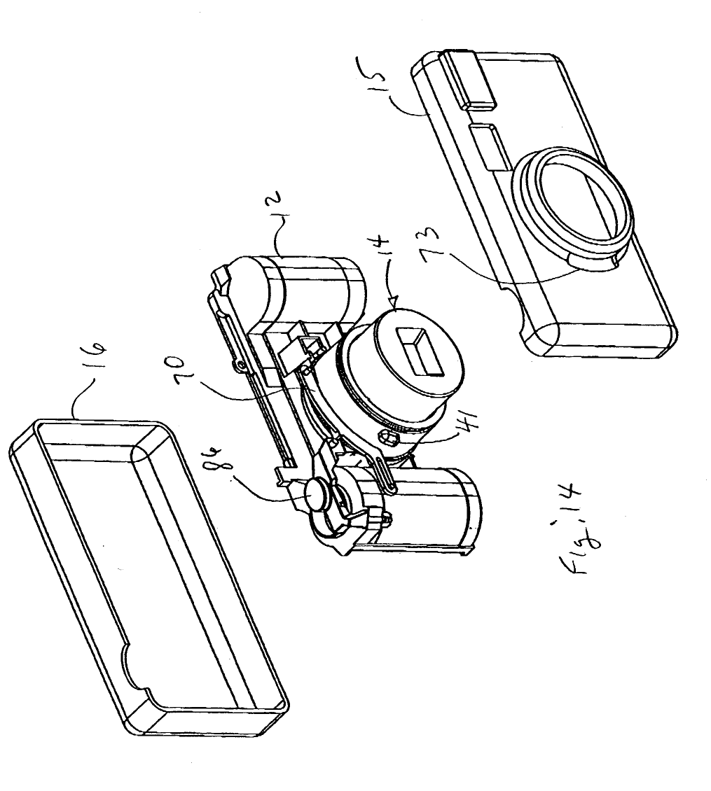

### DETAILED DESCRIPTION OF THE INVENTION

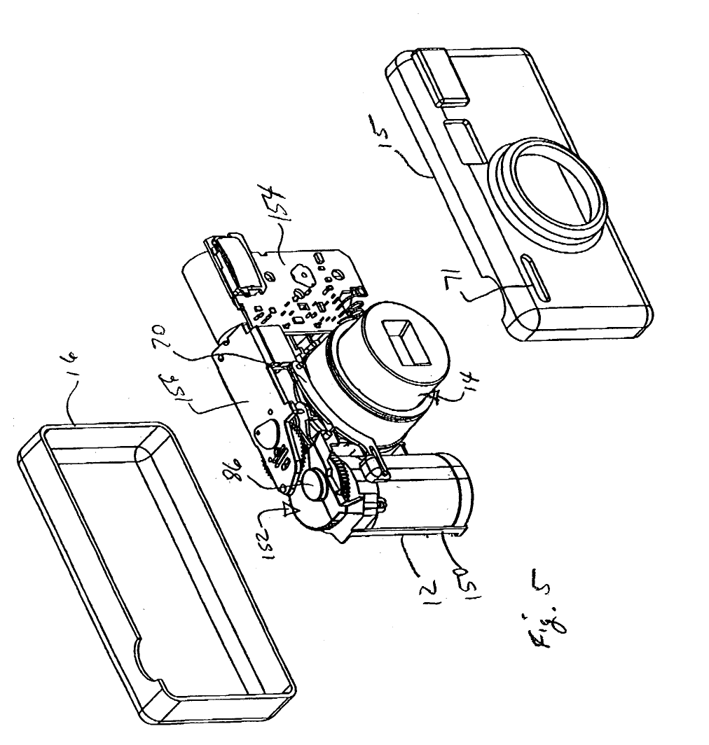

The camera frame assembly 10 has a frame 12 and a lens module 14 attached to the frame 12 or chassis. The term “camera frame assembly” is used here to refer to a complete camera or an incomplete subunit of a camera that can be assembled with other parts to form a complete camera. The invention is particularly advantageous in relation to a camera assembly that is a complete or incomplete one-time use camera. The frame 12 is held between front and rear covers 15,16 of the camera frame assembly 10. In the embodiments illustrated, the lens module 14 extends through an opening in the front cover 15. Referring to FIG. 5, the frame has a pair of opposed chambers 150, one can hold a film cartridge (not shown) and the other a film roll. A winding mechanism 152 advances film from the film roll, across a capture plane 19, and back into the film cartridge. A flash unit 154 can be included and synchronized with the shutter. A viewfinder-keeper plate 156 holds parts of the winding mechanism on the frame. The flash unit and other components are mounted to the frame 22 or held between the frame 22 and covers 13,15.

The camera frame assembly 10 includes a shutter mechanism 18 that is opened to direct light through a taking lens system to a capture plane 19. The figures illustrate a photographic film type camera, but the camera can use an electronic imager rather than photographic film for archival capture of images.

The shutter mechanism 18 includes a shutter release 20 that is mounted to the frame 12. The shutter release 20 is releasable by the user from a ready state to a released state. In particular embodiments of the invention, the shutter mechanism 18 includes an impact shutter 22 that is driven by a shutter driver 24 (sometimes referred to as a “high energy lever”). In these embodiments, the shutter driver 24 is charged by a film winding mechanism 40.

The winding mechanism 40 includes a combined thumbwheel and metering wheel 100 that is mounted for rotation adjacent a top corner of the rear cover 16. A portion of the wheel 100 extends beyond the rear cover 16 and is accessible to the camera operator. If desired, rather than being driven directly by the user, the wheel 100 can be driven by a winding knob, lever, electric motor or other like device.

Photographic film 102 is initially wound in a coil in one of the film chambers 150. The film extends across the capture plane 19 to the second film chamber 150, in which an end of the film is held by the spool 106 of a film cartridge 108. The wheel 100 has a key that couples the wheel 100 to the film cartridge spool 106, such that forward rotation of the wheel 100 causes the film to be wound into the cartridge 108 and advanced past the capture plane 19. An anti-backup pawl 109 is resiliently biased against an edge of the wheel 100 to prevent rotation in a reverse direction.

A film metering sprocket 110 has a shaft 112 that is pivotably supported by the frame 12. The sprocket 110 engages perforations in the film 102 and is rotated through a complete revolution each time the film 102 is advanced by a distance corresponding to one film frame.

An actuator disk 114 and a charging cam 116 are made in one piece with the sprocket 110 or are assembled with the sprocket 110 so as to remain in fixed (immobile) relation. The actuator disk 114 has a otherwise continuous circumference interrupted by a notch 118. The charging cam 116 has a spiral surface on one side and a spiral surface on the other side.

A film metering lever 120 is supported for pivotal movement by the frame 12. (The metering lever 120 and shutter driver 24 are illustrated as having empty, cylindrical cores that can receive upwardly extending posts provided on the frame 12. The metering lever 120 and shutter driver 24 can instead have shafts that fit in holes in the frame 12 and keeper plate 156.) The metering lever 120 is biased by a coil spring 122 in an activating direction. The metering lever 120 has a first arm 124 ending in a tooth and a second arm 126 having a pawl. When the toothed arm 124 of the metering lever 120 is received in the notch 118 of the actuator disk 114, the pawl arm 126 of the metering lever 120 engages the toothed rim of the wheel 100 temporarily blocking advancement of the film 102.

The shutter release member 20 includes a shutter button 86 that is located near the cantilevered end of a flexible arm 128 of the shutter release 20. Adjacent the shutter button 86 the arm 128 has a vertical tab that carries a latch member 28.

The shutter driver 24 is biased by a spring 130. The shutter driver 24 has a tongue 132 that is engaged by the latch member 28 to hold the shutter driver 24 in a charged state in opposition to the spring 130. The shutter driver 24 also has a cam follower finger 134 that is positioned so as to engage the charging cam 116.

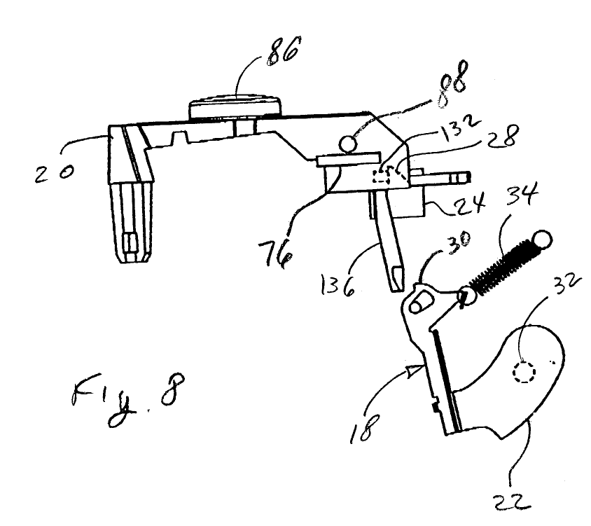

When the shutter driver 24 is in the charged state and the camera is in condition to make an exposure, as shown in FIG. 8, the tongue 132 of the shutter driver 24 is engaged by the latch member 28, which holds the shutter driver 24 in the charged condition in opposition to the spring 130. Prior to this during film advance, the sprocket 110 has been rotated into a position in which the toothed arm 124 of the metering lever 120 is in the notch 118 of the actuator disk 114. This allows the metering pawl arm 126 to engage the wheel 100 under the influence of the spring 130. The cam follower finger 134 of the shutter driver 24 is out of contact with the charging cam 116.

When the photographer depresses the shutter button 86 to initiate an exposure, the shutter release 20 is released from a ready state to a released state. The shutter button 86 moves the latch member 28 out of engagement with the tongue 132 of the shutter driver 24, the shutter driver 24 is pivoted rapidly by the spring 130 from the charged state to the discharged state. During this movement of the shutter driver 24, a protruding striker 136 of the shutter driver 24 impacts a tang 30 of the shutter 22, causing the shutter 22 to rotate from a closed state to an open state. This moves the shutter 14 away from the aperture 32 exposing a light image on the capture plane 19. The aperture 32 is uncovered momentarily. When the striker 136 moves past the tang 30 of the shutter, the shutter 22 returns to a closed state under the biasing of a shutter return spring 34 that is attached to the carrier 31.

After the film exposure has been completed, the user releases the shutter button 86. The shutter driver 24 moves into engagement with a downwardly extending yoke 138 of the metering lever 120. This causes the metering lever 120 to rotate to a deactivated position, by overpowering the weaker force exerted on the metering member 120 by a spring 130. Accordingly, the metering pawl arm 126 is disengaged from the wheel 100 and the metering member tooth arm 124 is retracted from the actuator disc notch 118. This allows the winding mechanism 40 to be operated to advance the film to the next available frame.

When the photographer next rotates the wheel 100 forward, the film is wound onto the spool. This causes the metering sprocket 110 to rotate in the same direction. The charging cam 116 engages the finger of the shutter driver 24 and rotates the latter back to a charged state.

A great variety of other suitable mechanisms 40 of this type are well-known to those of skill in art and are commonly used in currently available one-time-use cameras.

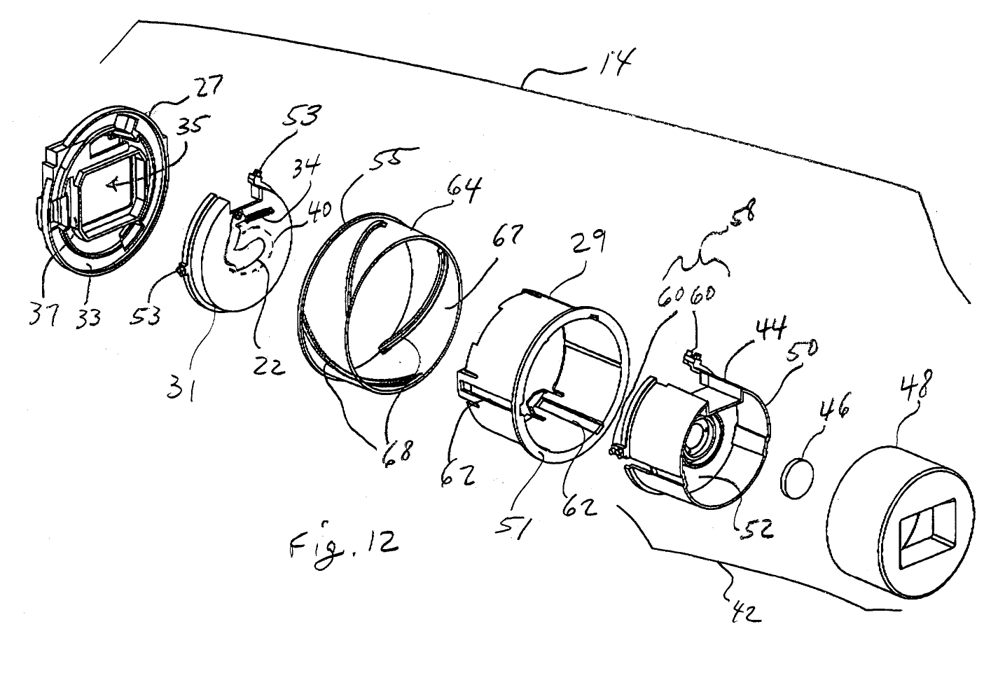

The lens module 14 has a lens base 36 that is mounted in a fixed position on the frame 12. (The term “fixed” and like terms are used herein in the sense of a physical position or relationship that is in immobile and unchanging.) The lens base 36 defines an optical axis 38. In particular embodiments of the invention, the lens base 36 includes a base lens element 40 (indicated in FIG. 12 by dashed lines) and optionally includes one or more additional lens elements (not shown).

The lens base 36 has a mount 27, a holder 29, and a carrier 31. The mount 27 joins the lens module 14 to the frame 12 and is configured so meet the requirements of a particular frame design. The mount 27 is fixed to the frame 12. The manner in which the mount 27 and other parts are attached to the frame 12 is not critical. For example, the mount 27 can be attached by a friction fit or by hooks or can be otherwise fastened or adhered or bonded.

The mount 27 has a forward-facing cup 33 (see FIG. 12) that receives the holder 29. A central opening 35 of the mount 27 can be bordered by a masking structure 37 that blocks unwanted light, so reducing flare. The holder 29 is snapped, adhered, or otherwise fastened in fixed relation to the mount 27. The mount 27 and holder 29 are conveniently provided as two pieces, but can be provided as a single piece.

A lens barrel 42 is joined to the lens base 36. The lens barrel 42 is movable forward and backward (indicated by double-headed arrow 25) along the optical axis 38 between a fully extended position and a fully retracted position. The movement of the lens barrel 42 may or may not include rotation about the optical axis 38.

The lens barrel 42, as shown in FIG. 12, includes a traveler 44 that acts as a support structure, a front lens element 46 held by the traveler 44, and a cap 48 that closes the forward end of the traveler 44. Optionally, one or more additional optical elements (not shown) are located within the traveler 44. The front and rear lens elements 46,40 and other lens elements (if any) together comprise a taking lens system that directs light to the capture plane 19.

In the illustrated embodiment, the traveler 44 has a cylindrical outside wall 50 and a cross wall 52 extending in a direction perpendicular to the optical axis 38. The cross wall 52 has a central opening and supports a front lens element 46.

A twist ring 64 is mounted on the lens base 36 and is trapped in place axially by a forward rim 51 of the holder 29. The twist ring 64 extends at least part of the way around the lens base 36. The twist ring 64 is reversibly rotatable relative to the lens base 36 from a rightward configuration through a plurality of intermediate configurations to a leftward configuration. (As with other directional terms herein, the terms “rightward” and “leftward” are used in a relative sense and are not limiting.) The twist ring 64 is mechanically coupled to the traveler 44, such that rotation of the twist ring 64 between the rightward and leftward configurations moves to the lens barrel 42 between the first and second positions, respectively. It is preferred that the twist ring 64 does not move axially during movement between the rightward and leftward configurations.

The traveler 44 includes a connector 58 that along with parts of the lens base 36 and twist ring 64 provides an extension-retraction mechanism. The connector 38 has three track followers 60. The track followers 60 can be equally spaced about the traveler 44 to help prevent the traveler 44 from canting relative to the lens base 36. Each track follower 60 has a pair of spaced apart posts 60a. The twist ring 64 has an engagement portion 66 that receives the connector 58 of the traveler 44 and constrains of the traveler 44 such that the traveler 44 moves forward and backward along the optical axis 38 when the twist ring 64 is rotated between the rightward and leftward configurations. The engagement portion 66 is a set of internal tracks 68 that each receive one of the track followers 60 of the traveler 44. In the embodiments illustrated herein, the tracks 68 are spiral ribs that extend toward the optical axis from the circumferential wall 67 of the twist ring 64. The tracks 68 are gripped between the posts 60a of the respective track followers 60. Alternatively, tracks 68 can be grooves or pairs of parallel fences that receive track followers 60 configured to ride in the grooves or between the fences.

The track followers 60 extend to the tracks 68 through corresponding slots 62 in the holder 29 of the lens base 36. The slots 43 each extend parallel to the optical axis 38. In the illustrated embodiments, there are three slots 62 and three corresponding track followers 60.

The track followers 60 slide along the tracks 68 when the twist ring 64 is rotated. Since the track followers 60 are held by the slots 62 of the lens base 36, this results in the lens barrel 42 traversing linearly inward or outward along the optical axis 38. After movement, the traveler 44 is held in a selected position by friction.

The engagement portion 66 and corresponding connector 58 can also be changed. For example, the engagement portion 66 and connector 58 can be meshed gears or the equivalent. Other mechanisms for retracting and extending a lens barrel using a twist ring are known to those of skill in the art.

The shutter 22 is mounted on the carrier 31 over the aperture 32. The shutter 22 pivots about a forwardly extending post 158. The carrier 31 has pegs 53 that extend outward in the same manner as the track followers 60 of the traveler 44. The pegs 53 are trapped within respective slots 62 of the holder 29 rearward of respective track followers 60. Three pegs 53 are provided on the same basis as the three track followers 60 of the traveler 44. The striker 136 of the shutter driver 24 is long enough to accommodate the axial movement of the carrier 31. In the illustrated embodiment, this movement is very slight and the striker is a couple of millimeters longer than would be required for a fixed position shutter.

The twist ring 64 has a rear margin 55 that is shaped into three cam surfaces (not shown) that face respective pegs 53. When the twist ring 44 is rotated, the pegs 53 move against respective cam surfaces. The movement is constrained by the slots 62 of the holder 29, such that the carrier 31 cannot rotate about the optical axis 38. The pegs 53 and track followers 60 can be biased against respective tracks and cam surfaces by springs or other resilient members (not shown), if desired.

A blocker 70 has a first end 72 joined to the frame 12 and a second end 74 connected to the twist ring 64. The blocker 70 and the twist ring 64 move together. The blocker 70 moves rectilinearly, in directions transverse to the optical axis 38, when the twist ring 64 rotates. The blocker 70 moves back and forth from a first unlocking position through a plurality of locking positions to a second unlocking position. The blocker 70 is in the locking positions when the twist ring 64 is in the intermediate configurations. The blocker 70 is in the first and second unlocking positions when the twist ring 64 is in the rightward and leftward configurations, respectively.

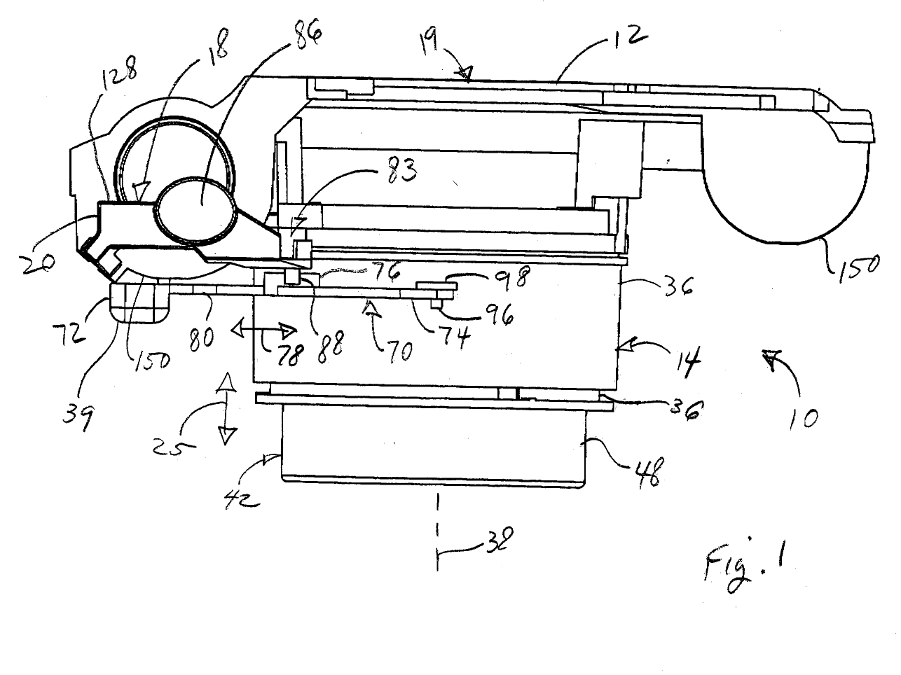

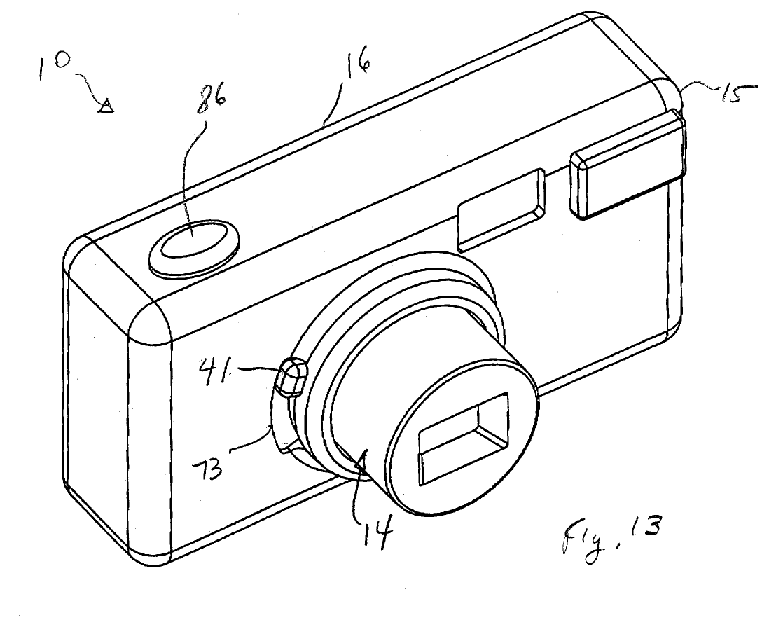

The lens barrel movement is manually powered by the user rotating the twist ring 64 or the sliding the blocker 70. Referring to FIG. 1, in a particular embodiment the first end of the blocker 70 includes a knob 39 that protrudes outward through a slot 71 in the front cover 15. In another embodiment shown in FIGS. 12-13, the twist ring 44 includes a knob 41 that protrudes through a slot 73 in the front cover 15. The knob 41 is moved by the user to rotate the twist ring 44. The lens barrel 14 can alternatively be powered rather than being operated manually.

The blocker 70 has an stop 76 located between the first and second ends 72,74. The stop 76 locks the shutter release 20 when the twist ring 64 is in the intermediate configurations and unlocks the shutter release 20 when the twist ring 64 is in one of the rightward and leftward configurations. The stop 76 is aligned with the shutter release 20 and interferes with movement of the shutter release 20 from the ready state to the released state, when the blocker 70 is in any of the locking positions.

In the illustrated embodiments, the blocker 70 is a lever having a first end 72 that is slidable relative to the frame 12. The second end 74 of the lever is pivotable about an axis that is parallel to the optical axis 38. The blocker 70 moves between positions rectilinearly in directions indicated by double-headed arrow 78. This movement is in a plane perpendicular to the optical axis 38. In the embodiments shown in the figures, the stop 76 of the blocker 70 is a shelf that extends rearwardly in an axial direction from the main portion 80 of the blocker 70. The shutter release 20 has a main support 82 that extends downward through a space indicated by arrow 83, behind the lens base 36, and pivots upward and downward, between the ready and released positions. A shutter button 86 extends upward from the main support 82. A boss 88 extends axially forward from the main support 82. The boss 88 and the stop 76 are aligned relative to the optical axis 38. When the shutter button 86 is pressed, the boss 88 sweeps downward into an area traveled by the stop 76 of the blocker 70. When the blocker 70 is in the locking positions, the stop 76 blocks the travel of the boss 88. The movement of the shutter release 20 can be completely blocked or some movement can be permitted. In either case, the available range of movement is insufficient for the tab 28 of the shutter release 20 to withdraw from the shutter driver 24. The shutter driver 24 is, thus, retained in the charged state and the shutter 22 remains closed. The lack of depression of the shutter button 86 also provides an indication to the user that a picture has not been taken. When the blocker 70 is in the first and second unlocking positions, the stop 76 is spaced from the region traveled by the boss 88 and full travel of the shutter release 20 can occur. In this case, the shutter driver 24 is released, the shuttter momentarily opens, and a picture is taken.

The manner in which the movement of the blocker 70 is guided is not critical. For example, in the illustrated embodiments, the first end 72 of the blocker has a longitudinal slot 90 that receives a pin 92 that extends outward from the remainder of the frame 12. The second end 74 has a hole that receives a pin 96 that extends outward from a tab 98. The tab 98 extends radially outwardly from the twist ring 64. Both pins 92,96 extend parallel to the optical axis 38. The blocker 70, in this case, has a curved portion that accommodates to curved shape of the twist ring 64 and relative location of the two pins 92,96. This feature can be modified to accommodate different positions of the parts and different kinds of connections. For example, the blocker 70 can be straight rather than curved. Likewise, the pins and opening in the blocker can be replaced with connections that flex in the required directions. The blocker 70 is illustrated as moving in a plane perpendicular to the optical axis 38. The movement can instead be skewed relative to that plane.

The invention has been described in detail with particular reference to certain preferred embodiments thereof, but it will be understood that variations and modifications can be effected within the spirit and scope of the invention.

What is claimed is:

1. A camera frame assembly comprising:
a frame;
a shutter release mounted to said frame, said shutter release being selectively releaseable from a ready state to a released state;
a lens base joined to said frame, said lens base defining an optical axis;
a lens barrel movable along said optical axis between a first position and a second position relative to said lens base; and
a twist ring held in unchanging axial relation to said lens base, said twist ring being rotatable relative to said lens base between rightward and leftward configurations and a plurality of intermediate configurations between said rightward and leftward configurations, said twist ring being mechanically coupled to said lens barrel, wherein rotation of said twist ring from said rightward configuration to said leftward configuration moves said lens barrel from said first position to said second position;
a blocker having a first end joined to said frame and a second end connected to said twist ring, said blocker having an engagement portion between said ends, said engagement portion locking said shutter release out of said released state when said twist ring is in said intermediate configurations, said shutter release being free of said locking when said twist ring is in one of said rightward and leftward configurations.

2. The camera frame assembly of claim 1 wherein said blocker is translateable by said twist ring between first and second unlocking positions and through a plurality of locking positions between said unlocking positions, said blocker being disposed in said locking positions when said twist ring is in said intermediate configurations, said blocker being disposed in said first and second unlocking positions when said twist ring is in said rightward and leftward configurations, respectively.

3. The camera frame assembly of claim 2 wherein said first end is slidable relative to said frame and said second end is pivotable about an axis parallel to said optical axis.

4. The camera frame assembly of claim 3 further comprising a shutter driver operatively connected to said shutter release and an impact shutter driven by said shutter driver.

5. The camera frame assembly of claim 1 wherein said blocker is disposed forward of said shutter release in a direction parallel to said optical axis.

6. The camera frame assembly of claim 5 wherein said blocker is translateable along a line defining a plane perpendicular to said optical axis.

7. The camera frame assembly of claim 6 wherein said blocker is spaced from said lens barrel.

8. The camera frame assembly of claim 1 further comprising front and rear covers mounted over said frame, said front cover having a slot, said blocker having a knob that protrudes through said slot.

9. The camera frame assembly of claim 1 further comprising front and rear covers mounted over said frame, said front cover having a slot, said twist ring having a knob that protrudes through said slot.

10. The camera frame assembly of claim 1 wherein said blocker is spaced from said lens barrel.

11. The camera frame assembly of claim 1 wherein said first end is slidable relative to said frame and said second end is pivotable about an axis parallel to said optical axis.

12. The camera frame assembly of claim 11 wherein said blocker is disposed forward of said shutter release in a direction parallel to said optical axis.

13. The camera frame assembly of claim 1 further comprising a shutter driver operatively connected to said shutter release and an impact shutter driven by said shutter driver.

14. The camera frame assembly of claim 1 further comprising a rear lens element mounted in said lens base.

15. A camera frame assembly comprising:
a frame;
a shutter release mounted to said frame;
a lens base defining an optical axis;
a twist ring held in unchanging axial relation to said lens base, said twist ring being rotatable relative to said lens base between rightward and leftward configurations and a plurality of intermediate configurations between said rightward and leftward configurations;
a blocker having a first end joined to said frame and a second end connected to said twist ring, said blocker being movable rectilinearly by said twist ring, in directions transverse to said optical axis, between first and second unlocking positions and through a plurality of locking positions between said unlocking positions, said blocker being disposed in said locking positions when said twist ring is in said intermediate configurations, said blocker being disposed in said first and second unlocking positions when said twist ring is in said rightward and leftward configurations, respectively, said blocker having an engagement portion between said ends, said engagement portion locking said shutter release when said twist right is in said intermediate configurations, said engagement portion unlocking said shutter release when said twist ring is in one of said rightward and leftward configurations.

16. The camera frame assembly of claim 15 further comprising a traveler mechanically coupled to said twist ring, wherein rotation of said twist ring from said rightward configuration to said leftward configuration moves said traveler from said first position to said second position.

17. The camera frame assembly of claim 16 further comprising a front lens element mounted in said traveler and a rear lens element mounted in said lens base.

18. The camera frame assembly of claim 17 wherein said engagement portion is axially aligned with said twist ring.

19. The camera frame assembly of claim 18 wherein said first end is slidable relative to said frame and said second end is pivotable about an axis parallel to said optical axis.

20. The camera frame assembly of claim 17 wherein said first end is slidable relative to said frame and said second end is pivotable about an axis parallel to said optical axis.
